(19) United States
(12) Patent Application Publication
(10) Pub. No.: US 2018/0087953 A1
(43) Pub. Date: Mar. 29, 2018

(54) Contactless Fluid Level Sensor

(71) Applicant: Methode Electronics Malta Ltd., Mriehel (MT)

(72) Inventors: Allen Carl Bonnici, Mosta (MT); Alexander Galea, Dingli (MT)

(21) Appl. No.: 15/709,939

(22) Filed: Sep. 20, 2017

(30) Foreign Application Priority Data
Sep. 27, 2016 (DE) 10 2016 118 266.4

(51) Int. Cl. G01F 23/38

(52) U.S. Cl. CPC G01F 23/38

(57) ABSTRACT

A fluid level sensor includes a magnetic field generator that generates a magnetic field varying with time. A metallic member is disposed in a region in which the magnetic field generated by the magnetic field generator is present. The metallic member is movable relative to the magnetic field generated by the magnetic field generator based upon a fluid level to be measured. The metallic member has an effective geometry defining the magnitude of eddy currents induced in the metallic member due to the magnetic field generated by the magnetic field generator. The effective geometry is changed when the metallic member is moved relative to the magnetic field generator. A sensing device detects the eddy currents induced in the metallic member, and a fluid level determination device determines the fluid level based on the eddy currents induced in the metallic member. A method of use of the device is also disclosed.

### RELATED APPLICATION DATA

This application claims the benefit of German patent application no. DE 10 2016 118 266.4 filed on Sep. 27, 2016, currently pending the disclosure of which is incorporated by reference herein.

### BACKGROUND

The present disclosure relates to a fluid level sensor as well as to methods for detecting a fluid level and use of a sensing device for determining a fluid level.

Currently many fluid level sensors, especially fuel gauges, make use of a potentiometer type sensor with a movable member or movable element being used to indicate the fluid level in, for example, a fuel tank of a motor vehicle. Often the movable element is mounted on a rotary member which is interconnected to a float which moves up and down with the fluid level, translating the linear motion for the floating element due to the varying level of the fluid into rotary motion. In this type of fluid level sensor a contact element connected to the movable element closes a contact on a potentiometer in a certain position based on the fluid level. The respective value of the resistivity is therefore indicative of the fluid level.

In this type of fluid level sensor the sensing elements are most of the time immersed in fuel (typically petrol or diesel). Due to their chemistry, fuels are very aggressive on materials including the special materials used for the potentiometer and/or the potentiometer sensing element. This results in frequent sensor failures resulting in customer dissatisfaction.

In order to overcome the necessity to use a potentiometer which is, as mentioned above, vulnerable to wear, another type of fluid level sensor comprising a Hall effect sensor to measure the position of the float with a magnet was introduced. In the case of use of a Hall effect sensor, however, an expensive moving magnet is required to operate the sensor. Also the sensor itself is, due to the complicated measurement it has to perform, expensive in its production.

Considering the above-mentioned drawbacks of fluid level sensors according to the prior art, it is an object of the disclosure herein to provide a fluid level sensor which is wear resistant and which is furthermore easy to produce with low production costs. In addition, it is an object of the present the disclosure herein to provide a method for detecting a fluid level which can be easily performed and in which the respective used devices show the above-mentioned properties.

### SUMMARY

A fluid level sensor according to the present disclosure comprises a magnetic field generator adapted to generate a magnetic field which is varying with time and a metallic member being disposed in a region in which the magnetic field generated by the magnetic field generator is present. The metallic member is disposed movable, in particular rotatably movable, relative to the magnetic field generator and/or the magnetic field generated by the magnetic field generator and dependent on a fluid level to be measured. Said metallic member comprises an effective geometry defining the magnitude of eddy currents induced in the metallic member due to the magnetic field generated by the magnetic field generator. The effective geometry defining the magnitude of eddy currents induced in the metallic member due to the magnetic field is changed when the metallic member is moved relative to the magnetic field generator. The sensor comprises, furthermore, a sensing device adapted to detect the eddy currents induced in the metallic member and a fluid level determination device determining the fluid level based on the eddy currents induced in the metallic member.

Since the fluid level determination is based on eddy currents, a measurement principle which is easy to handle can be used. The respective components are cheap in production and the use of an expensive magnet designed for Hall effect measurements can be avoided.

Furthermore, one may considered placing the magnetic field generator and/or the sensing device and/or the fluid level determination device in a manner separated from the metallic member. In particular, the aforementioned components might be placed outside of a fuel tank or a fluid tank or the afore-mentioned components might be placed in a housing which might be sealed in a fluid-tight manner. With such a construction the respective components are not immersed in fuel or fluids the level of which shall be measured.

In a possible embodiment the above-mentioned magnetic field which is varying with time is an oscillating magnetic field. In this construction a common oscillator might be used as an excitation source for the magnetic field generator. In a further possible embodiment the magnetic field generator itself is a coil. As mentioned above, the fluid level sensor can comprise in this case an oscillator which powers the coil.

The coil can be a multiple layer continuous spiral shape printed coil which is arranged on or is part of a printed circuit board (PCB). The sensing device might comprise a micro-controller. A soft metal core is disposed in a region in which the magnetic field generated by the magnetic field generator and therefore also the magnetic field generated by the eddy currents which is superimposed to the magnetic field generated by the magnetic field generator is present.

The sensing device detects preferably the frequency of the resulting magnetic field. The sensing device is able to detect the change in frequency when an appropriate component, e.g. a metallic member is moved relative to the magnetic field.

For the movement of the metallic member a float can be used which is adapted to move the metallic member relative to the magnetic field generator and therefore relative to the magnetic field.

In a possible embodiment the fluid level sensor comprises a movable member which is integrally formed with the (accordingly movable) metallic member. The movable member accommodates and surrounds the metallic member, in particular to protect same against decomposition and/or degradation due to the fluids the level of which shall be measured.

The movable member is in a possible embodiment disposed rotatably movable relative to the magnetic field generator and/or the housing and may be pivoted by a pivot pin at the housing. The connection of the movable member (or the metallic member) to the float is optionally effected by means of a lever which is connected at one of its ends to the float and at its other end to the movable member or the metallic element.

In an aspect of a method the present disclosure, a method for detecting a fluid level is provided. The method comprises the steps of:
providing a magnetic field which is varying with time by means of a magnetic field generator,
measuring the magnitude of eddy currents induced in a metallic member being disposed in a region in which the magnetic field is present and being disposed movable, in particular rotatably movable, relative to the magnetic field, said metallic member comprising an effective geometry defining the magnitude of eddy currents induced in the metallic member due to the magnetic field, wherein the effective geometry defining the magnitude of eddy currents induced in the metallic member due to the magnetic field is changed when the metallic member is moved relative to the magnetic field,
determining the magnitude of eddy currents induced in the metallic member, and
determining the position of the metallic member relative to the magnetic field using the magnitude of the eddy currents induced in the metallic member.

The aforementioned method can be performed easily while the respective components needed for performing the method are cheap in production and show an enlarged wear resistance.

Analogously to the apparatus described above, the step of providing a magnetic field which is varying with time may be a step of providing an oscillating magnetic field.

Also analogously to the apparatus described above, the magnetic field might be generated by means of a magnetic coil wherein the magnitude of eddy currents induced in the metallic member is determined based on the impedance of the coil. Alternatively or as an intermediate step for determining the impedance of the coil, the frequency of a resulting magnetic field which is the resulting magnetic field obtained by superimposition of the magnetic field generated by the magnetic field generator and the magnetic field generated by the eddy currents (induced in the metallic member) may be determined.

The disclosure also covers the use of a sensing device adapted to detect the magnitude of eddy currents and induced in a movable metallic member for determining a fluid level.

### DESCRIPTION OF THE DRAWINGS

Further optional features of the invention are set forth in the dependent claims and in the following description of the figures. The described features can in each case be realized individually or in any desired combinations. Accordingly, the invention is described below with reference to the appended drawings and on the basis of illustrative embodiments. In the drawings:

FIG. 1 shows an exemplary embodiment of a fluid level sensor according to the present invention

FIG. 2 shows an enlarged view of a portion of the fluid level sensor according to FIG. 1

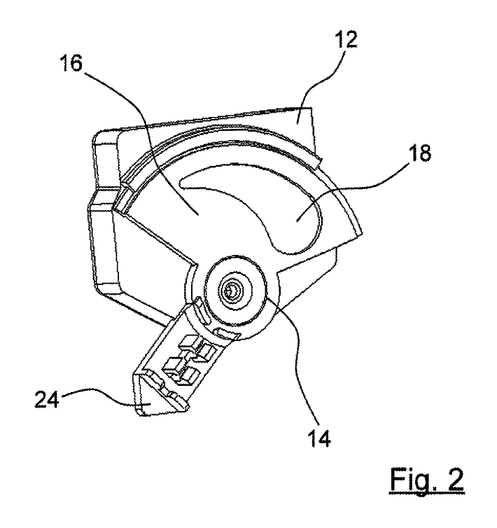

FIG. 3 shows a cross-sectional view of the portion of the fluid level sensor according to FIG. 2

FIG. 4 shows a view of the fluid level sensor according to FIG. 1 in a position taken in an empty tank, and

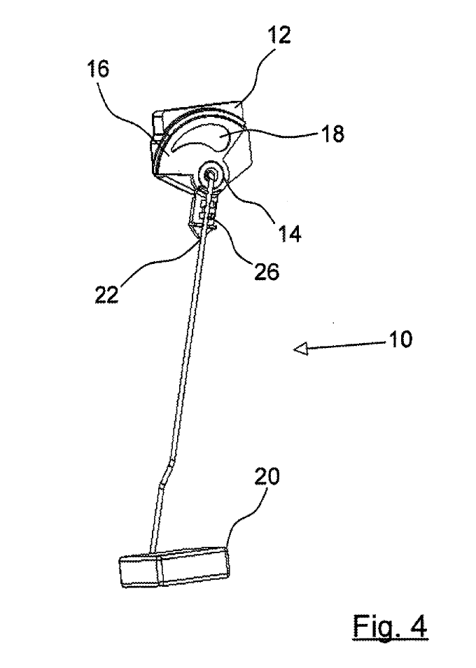

FIG. 5 shows an exploded view of the detail of FIG. 2.

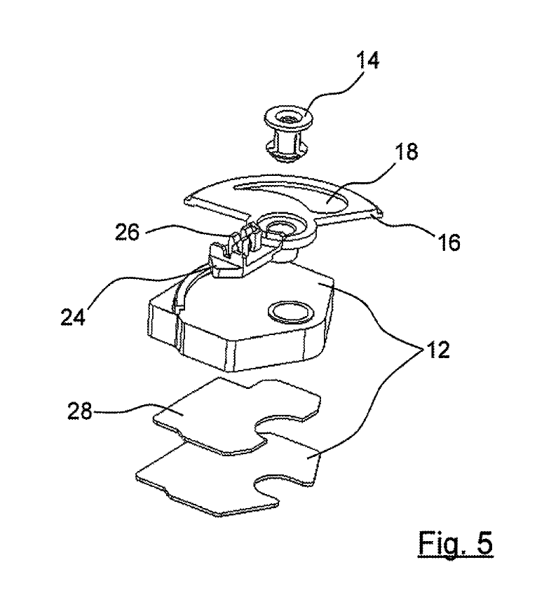

### DETAILED DESCRIPTION

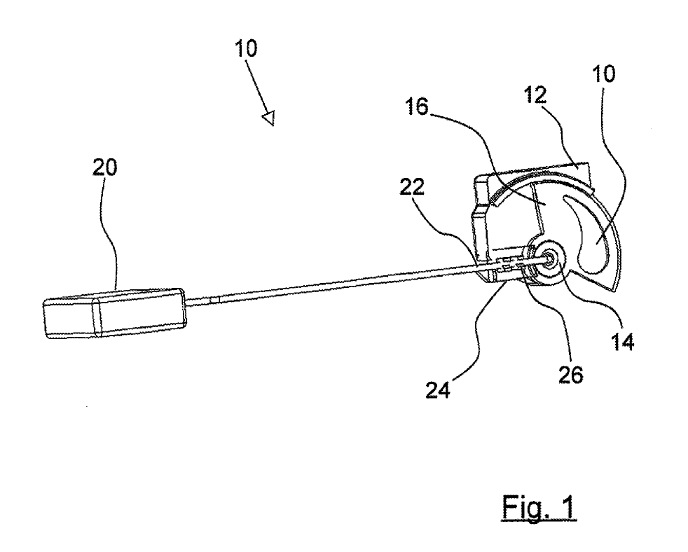

As can be seen for example from FIG. 1, a possible embodiment of a fluid level sensor 10 according to one embodiment comprises a housing 12 to which, by means of a pivot pin 14, a movable element 16 is connected. In the presently discussed embodiment the movable element 16 is able to rotate around the pivot pin 14 and, therefore, to rotate relative to the housing 12.

The movable element 16 is integrally formed with a metallic member 18 which is accommodated in and surrounded by the movable element 16. The metallic member 18 is made of a metallic material. In particular a metallic material which is neither ferromagnetic nor ferrimagnetic, for example aluminum, may be used. However, the sensor will also give reliable results if a ferromagnetic or ferrimagnetic material is used. The movable element 16 is in the presently described embodiment formed of a resin. Alternatively also other materials may be used, in particular non-metallic materials and/or electrically insulating materials.

The fluid level sensor 10 comprises a float 20 which is connected to the movable element 16 by means of a lever 22. For a safe connection the movable element 16 comprises a holding portion 24 in which the lever 22 can be fixed via clamps 26. Instead of a fixation by means of the clamps 26 any other method for fixing the lever 22 at the movable member 16 may be considered, in particular fixing same by means of an adhesive material or by welding or soldering.

The float 20 is in the present embodiment made of a material adapted to float on the fluid the level of which shall be measured. In other possible embodiments only parts of the float 20 may be made of a material which is able to float on a fluid. In further embodiments the float 20 may be formed of a hollow body made of a material which also might not be able to float on a fluid. The lever 22 is of a rod-shaped or cylinder-shaped form. In alternative embodiments, any other shape is conceivable.

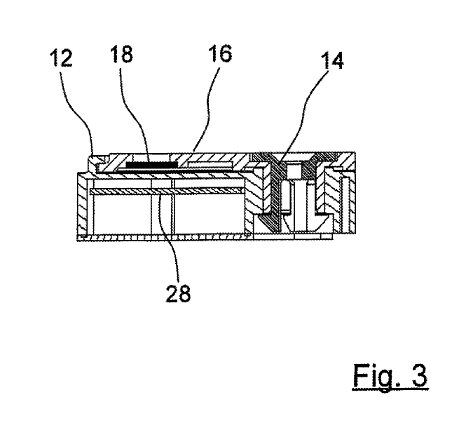

As can be seen in particular from FIG. 3, in the housing 12 a printed circuit board 28 is arranged. The printed circuit board comprises a magnetic field generator implemented as a multiple layer continuous spiral-shape printed coil, an oscillator circuit for driving the magnetic field generator and a sensing device. The sensing device is implemented by a micro-controller. A soft metal core is placed in the resulting magnetic field (not shown). The housing 12 is sealed against its environment by means of a seal (not shown) in order to protect the components accommodated in the housing in a fluid-tight manner.

The magnetic field generator (coil) is adapted to generate, powered by the oscillator circuit, an oscillating magnetic field (i.e. a magnetic field which is varying with time). The metallic member 18 is disposed in a region in which the magnetic field generated by the magnetic field generator is present. The metallic member 18 and therefore the movable element 16 are disposed movable, in particular rotatably movable relative to the magnetic field generator and the magnetic field generated by the magnetic field generator. The movement of the metallic member 18 and therefore the movement of the movable element 16 are caused by the movement of the float 20, i.e. dependent on a fluid level to be measured, wherein the linear movement of the float 20 is converted by means of the pivot pin 14 into a rotational motion of the movable element 16 and the metallic element 18 accommodated therein.

Said metallic member 18 comprises an effective geometry defining the magnitude of eddy currents induced in the metallic member due to the magnetic field generated by the magnetic field generator (generally the magnitude of eddy currents induced is defined by an area which is exposed to the magnetic field). The metallic member 18 is designed such that the effective geometry of same is changing when the metallic member 18 is moved relative to the magnetic field generator. For this reason eddy currents induced in the metallic element 18 are in each position of the metallic element 18 relative to the magnetic field different and unique. Therefore, also the magnetic field caused by the eddy currents is in in each position of the metallic element 18 relative to the magnetic field different and unique.

Using the sensing device it is possible to detect the eddy currents induced in the metallic member. This can be done in several ways. In particular the determination of the eddy currents can be performed based on the change of the impedance of the coil and/or based on the shift in frequency of a resulting magnetic field which is the resulting magnetic field being obtained by superimposing the magnetic field which is generated by means of the magnetic field generator with the magnetic field which is generated due to the eddy currents induced in the metallic member. In the presently described embodiment the sensing device is, as mentioned above, a micro-controller. A soft metal core is placed in the resulting magnetic field. The micro-controller detects the frequency of the resulting magnetic field and therefore the change in frequency when the metallic member 18 is moved relative to the magnetic field.

For indicating a fluid level based on the result output by the sensing device the sensor 10 comprises a fluid level determination device determining the fluid level based on said result, i.e. the eddy currents induced in the metallic member.

The metallic member 18 is, as mentioned above, designed such that the effective geometry of same is changing when the metallic member 18 is moved relative to the magnetic field generator. Therefore, in the presently described embodiment, the radial extension of the metallic element 18 increases when the metallic member 18 (the movable element 16) is rotated around the pivot pin 14. This means that—when a virtual line in a radial direction is imagined which is intersecting the metallic element —there will be two intersecting points which are the edges of the metallic element. When the metallic element is moved the intersecting points will have a different distance from each other, wherein the distance is monotonically increasing when starting from a position representing a full tank and wherein the distance is monotonically decreasing when starting from a position representing an empty tank or vice-versa.

In summary, the sensor 10 comprises a housing 12 which encloses a sensor circuit on PCB element 28 which is hermetically sealed against fluids inside housing 12. On the outside of the sealed housing 12, a varying geometry metal target (metallic member 18) is disposed which forms an integral part of a rotating element (movable element 16) which rotates around pivot pin 14 when connected to a floating element (float 20) through lever 22 and holding portion 24 to translate the linear motion of the floating element into a rotary motion of the metal target. The sensor circuit does not require any permanent magnetic field and makes use of Eddy current effect when the varying geometry metal target moves/rotates. An eddy current circuit is made up of a multiple layer continuous spiral shape printed coil on the PCB, an oscillator circuit and a micro-controller to process the change in impedance of the coil as the metal target goes through the oscillating magnetic field.

In another aspect of the disclosure, a method for detecting a fluid level is provided comprising the steps of:
providing a magnetic field which is varying with time by means of a magnetic field generator,
measuring the magnitude of eddy currents induced in a metallic member 18 being disposed in a region in which the magnetic field is present and being disposed movable, in particular rotatably movable, relative to the magnetic field, said metallic member 18 comprising an effective geometry defining the magnitude of eddy currents induced in the metallic member 18 due to the magnetic field, wherein the effective geometry defining the magnitude of eddy currents induced in the metallic member 18 due to the magnetic field is changed when the metallic member 18 is moved relative to the magnetic field,
determining the magnitude of eddy currents induced in the metallic member 18, and
determining the position of the metallic member 18 relative to the magnetic field using the magnitude of the eddy currents induced in the metallic member 18.

In the embodiment shown in the Figures the step of providing a magnetic field which is varying with time is a step of providing an oscillating magnetic field and the magnetic field is generated by means of a coil. The magnitude of eddy currents induced in the metallic member is determined based on the impedance of the coil. The magnitude of the impedance of the coil is determined based on the frequency of a resulting magnetic field which is the resulting magnetic field being obtained by superimposing the magnetic field which is generated by means of the magnetic field generator with the magnetic field which is generated due to the eddy currents induced in the metallic member.

### LIST OF REFERENCE NUMERALS

10 fluid level sensor

12 housing

14 pivot pin

16 movable element

18 metallic member

20 float

22 lever

24 holding portion

26 clamps

28 printed circuit board

1. A fluid level sensor (10) comprising:
a magnetic field generator adapted to generate a magnetic field which is varying with time,
a metallic member (18) being disposed in a region in which the magnetic field generated by the magnetic field generator is present, the metallic member being movable relative to the magnetic field generated by the magnetic field generator based upon a fluid level to be measured, said metallic member (18) comprising an effective geometry defining the magnitude of eddy currents induced in the metallic member (18) due to the magnetic field generated by the magnetic field generator, wherein the effective geometry defining the magnitude of eddy currents induced in the metallic member (18) due to the magnetic field is changed when the metallic member (18) is moved relative to the magnetic field generator,
a sensing device adapted to detect the eddy currents induced in the metallic member (18), and
a fluid level determination device determining the fluid level based on the eddy currents induced in the metallic member (18).

2. The fluid level sensor (10) according to claim 1, wherein the magnetic field which is varying with time is an oscillating magnetic field.

3. The fluid level sensor (10) according to claim 1, wherein the magnetic field generator is a coil and wherein the fluid level sensor (10) comprises an oscillator which powers the coil.

4. The fluid level sensor (10) according to claim 3, wherein the coil is a multiple layer continuous spiral shape printed coil which is arranged on a printed circuit board (28).

5. The fluid level sensor (10) according to claim 1, wherein the sensing device is a micro-controller with a soft metal core, and wherein the soft metal core is disposed in a region in which the magnetic field generated by the magnetic field generator is present.

6. The fluid level sensor (10) according to claim 1, wherein the fluid level sensor (10) comprises a float (20) adapted to move the metallic member (18) relative to the magnetic field generator.

7. The fluid level sensor (10) according to claim 1, wherein the fluid level sensor comprises a housing (12) accommodating at least one of a part of the magnetic field generator and the sensing device, and wherein the housing (12) is sealed in a fluid-tight manner.

8. The fluid level sensor (10) according to claim 1, wherein the fluid level sensor (10) comprises a movable member (16) which is integrally formed with the metallic member (18) and which accommodates and surrounds the metallic member (18).

9. The fluid level sensor (10) according to claim 8, wherein the movable member (16) is rotatably movable relative to at least one of the magnetic field generator and the housing (12).

10. The fluid level sensor (10) according to claim 9, wherein the movable member (16) is rotatably movable relative to at least one of the magnetic field generator and the housing (12) by a pivot pin (14) at the housing (12).

11. The fluid level sensor (10) according to claim 8, wherein the movable member (16) is connected to a float (20).

12. A method for detecting a fluid level comprising the steps of:
providing a magnetic field which is varying with time by means of a magnetic field generator,
measuring the magnitude of eddy currents induced in a metallic member (18) disposed in a region in which the magnetic field is present, wherein the metallic member(18) is movable relative to the magnetic field and comprises an effective geometry defining the magnitude of eddy currents induced in the metallic member (18) due to the magnetic field, wherein the effective geometry defining the magnitude of eddy currents induced in the metallic member (18) due to the magnetic field is changed when the metallic member (18) is moved relative to the magnetic field,
determining the magnitude of eddy currents induced in the metallic member (18), and
determining the position of the metallic member (18) relative to the magnetic field using the magnitude of the eddy currents induced in the metallic member (18).

13. The method according to claim 12, wherein the step of providing the magnetic field which is varying with time includes providing an oscillating magnetic field.

14. The method according to claim 12, wherein the step of providing the magnetic field includes generating the magnetic field via a coil.

15. The method according to claim 14, wherein the magnitude of eddy currents induced in the metallic member (18) is determined based on the impedance of the coil.

16. The method according to claim 15, wherein the impedance of the coil is determined based upon the frequency of a resulting magnetic field wherein the resulting magnetic field is obtained by superimposing the magnetic field which is generated by the magnetic field generator with the magnetic field which is generated due to the eddy currents induced in the metallic member (18).

17. The method according to claim 12, wherein the magnitude of eddy currents induced in the metallic member (18) is determined based upon the frequency of a resulting magnetic field wherein the resulting magnetic field is obtained by superimposing the magnetic field which is generated by the magnetic field generator with the magnetic field which is generated due to the eddy currents induced in the metallic member (18).

18. The method according to claim 12, further comprising determining a fluid level based upon the determination of the position of the movable metallic member (18).
